(19) United States
(12) Patent Application Publication
(10) Pub. No.: US 2012/0249610 A1
(43) Pub. Date: Oct. 4, 2012

(54) DISPLAY DEVICE AND DISPLAY METHOD THEREFOR

(75) Inventors: Masayuki Katagami, Osaka-shi (JP); Atsushi Ban, Osaka-shi (JP); Toshihide Tsubata, Osaka-shi (JP); Takehisa Yoshida, Osaka-shi (JP)

(73) Assignee: SHARP KABUSHIKI KAISHA, Osaka-shi, Osaka (JP)

(21) Appl. No.: 13/498,149

(22) PCT Filed: May 19, 2010
(86) PCT No.: PCT/JP2010/058412

§ 371 Date: Jun. 15, 2012

(30) Foreign Application Priority Data
Sep. 28, 2009 (JP) 2009-221875

(51) Int. Cl. G09G 5/10

(52) U.S. Cl. 345/690

(57) ABSTRACT

In the present display device with each pixel being composed of subpixels of four or more colors, a backlight data processing portion sets a backlight source luminance to be high enough to compensate for a display luminance reduction caused by a maximum luminance adjustment portion (332) multiplying input pixel data for G by an adjustment gain, such that the value of the input pixel data for G does not exceed the maximum pixel value, after a G correction portion (331) corrects the input pixel data for G to compensate for a display luminance reduction due to the area of (subpixel) G being half of others. Thus, it is possible to realize high color reproducibility and a high luminance as realized by conventional liquid crystal display devices with a three-color, RGB, pixel configuration.

### TECHNICAL FIELD

The present invention relates to display devices, more specifically to a display device including a display panel with each pixel being composed of subpixels of four or more colors.

### BACKGROUND ART

Conventionally, liquid crystal display devices use color filters of three colors, red, green, and blue (RGB), to provide color image display. In such a liquid crystal display device, each pixel is composed of pixels representing three colors, red, green, and blue (each being referred to as a “subpixel”), as shown in FIG. 7. By adjusting transmittance for each subpixel, a desired color is displayed in each pixel. Recent years have seen increasing demand for such liquid crystal display devices to have a wider range of color reproduction (enhanced color reproducibility). Moreover, liquid crystal display devices, such as portable electronic devices, are increasingly used outdoors, and to ensure satisfactory visibility in the environment with intense outside light, there is also increasing demand for higher luminances. Note that in the following descriptions, red, green, and blue will be abbreviated as “R”, “G”, and “B”, respectively. Moreover, for example, a “red image signal” will be referred to as an “R image signal”.

Incidentally, deepening the color of the color filters to widen the range of color reproduction reduces transmittance, resulting in a low luminance. Therefore, there have been proposed liquid crystal display devices with each pixel being composed of subpixels of four colors in order to inhibit luminance reduction. For example, a known liquid crystal display device uses white (W) subpixels, in addition to subpixels of the three primary colors, R, G, and B, as shown in FIG. 8. This liquid crystal display device transmits light through the W subpixels, thereby obtaining the maximum luminance about 1.6 times of that of liquid crystal display devices with each pixel being composed of subpixels of the three primary colors, R, G, and B.

However, in the case of the liquid crystal display device with the pixel configuration as shown in FIG. 8, for example, when a line of the primary color red is displayed on a white background, a low luminance of the R subpixels causes the red to be extremely dark, so that the primary color red is not clearly displayed. Therefore, some conventional liquid crystal display devices employ a pixel configuration as shown in FIG. 9, where areas of W and G, which have high luminances, are simply reduced. This configuration can increase color reproducibility without darkening R and B.

Note that Japanese Laid-Open Patent Publication No. 2004-118133 discloses an invention of a liquid crystal display device with a different configuration from the configurations described above, in which two or more types of color filters and a plurality (e.g., 4) of types of light sources are provided, and the light sources are sequentially lit one by one within one frame period. In this liquid crystal display device, when the light sources are lit to emit light transmitted through two or more types of color filters, color filters of at least one type are brought into a closed state, thereby providing image display with high color reproducibility using, for example, four colors, R, G, B, and W.

### CITATION LIST

### Patent Document

Patent Document 1: Japanese Laid-Open Patent Publication No. 2004-118133

### SUMMARY OF THE INVENTION

### Problems to be Solved by the Invention

However, when, in the first place, a liquid crystal display device with each pixel being composed of subpixels of four colors provides monochromatic or similar display, resulting in a lower luminance compared to liquid crystal display devices with each pixel being composed of subpixels of three colors. The reason for this is that, for example, when the liquid crystal display device with subpixels of four colors, R, G, B, and W, provides monochromatic display, the W subpixels are displayed as black, and focusing on the opening area for each entire pixel, the liquid crystal display device with subpixels of four colors has a smaller opening area than the liquid crystal display devices with subpixels of three colors. Thus, so long as each pixel is composed of subpixels of four colors, it is inevitable to have a low (pixel) luminance for monochromatic display, and there is difficulty in always achieving both high color reproducibility and a high luminance.

Furthermore, in the liquid crystal display device with the pixel configuration shown in FIG. 9, the area of G is half compared to the liquid crystal display device with the pixel configuration shown in FIG. 7 where each pixel is composed of subpixels of three colors. Accordingly, even if the luminance of G per unit area (i.e., light transmittance for G) is high, the total display luminance (luminosity) for G might be deficient, resulting in poor balance among colors (R, G, and B).

Furthermore, the invention of a liquid crystal display device disclosed in Japanese Laid-Open Patent Publication No. 2004-118133 is intended to be applied to liquid crystal display devices that provide color display in a field-sequential system but not to be applied to liquid crystal display devices that provide color display via spatial pixel segmentation.

Therefore, an objective of the present invention is to provide a display device having a display panel with each pixel being composed of subpixels of four or more colors, in which a high luminance is achieved while maintaining color balance.

### Solution to the Problems

A first aspect of the present invention is directed to a display device having a function of controlling a backlight luminance, comprising:

a display panel for displaying an image on the basis of external video data, having each pixel being composed of subpixels of four or more colors;

a backlight including light sources whose luminances are controllable;

a luminance adjustment portion for, when a tone value exceeding a predetermined limit is to be provided to any subpixel of a specific color among all pixels included in the display panel, decreasing tone values to be provided to all subpixels of the specific color to a predetermined limit or less and correspondingly decreasing tone values to be provided to all subpixels of the other colors; and

a lighting control portion for controlling the luminances of the light sources to increase, thereby compensating for a display luminance reduction of the subpixels due to the tone values being decreased.

In a second aspect of the present invention, based on the first aspect of the invention, the display device further comprises a maximum value calculation portion for calculating a maximum of the tone values to be provided to the subpixels of the specific color included in the video data for one frame period, when the maximum value calculated by the maximum value calculation portion is greater than or equal to a predetermined limit, the luminance adjustment portion decreases the tone values, and the lighting control portion controls the luminances of the light sources to increase in accordance with the maximum value calculated by the maximum value calculation portion.

In a third aspect of the present invention, based on the first aspect of the invention, the luminance adjustment portion includes:

a specific-color correction portion for multiplying the tone values to be provided to the subpixels of the specific color by a predetermined correction gain, thereby generating corrected tone values to be provided to the subpixels of the specific color; and

a luminance decrease adjustment portion for, when any of the corrected tone values is greater than or equal to the limit, multiplying both the corrected tone values and the tone values to be provided to the subpixels of the other colors by a predetermined adjustment gain, thereby decreasing the tone values.

In a fourth aspect of the present invention, based on the first aspect of the invention, the luminance adjustment portion includes a polychromatic allocation portion for allocating red, green, and blue pixel data included in the video data to the tone values to be provided to the subpixels of four or more colors.

In a fifth aspect of the present invention, based on the first aspect of the invention, each of the pixels includes at least a white subpixel, in addition to red, green, and blue subpixels.

In a sixth aspect of the present invention, based on the fifth aspect of the invention, the specific color is green, and the green subpixel has a smaller display area than at least one of the subpixels of the other colors.

In a seventh aspect of the present invention, based on the first aspect of the invention, each of the pixels includes a yellow or cyan subpixel, or subpixels of both colors, in addition to red, green, and blue subpixels.

In an eighth aspect of the present invention, based on the first aspect of the invention, the subpixels of the specific color have a lower relative luminance than the subpixels of the other colors.

A ninth aspect of the present invention is directed to a display method for a display device having a function of controlling a luminance of a backlight, the method comprising:

a luminance adjustment step of, when a tone value exceeding a predetermined limit is to be provided to any subpixel of a specific color among all pixels included in a display panel, decreasing tone values to be provided to all subpixels of the specific color to a predetermined limit or less and correspondingly decreasing tone values to be provided to all subpixels of the other colors, wherein the display panel has pixels each being composed of subpixels of four or more colors, and displays an image on the basis of external video data; and

a lighting control step of controlling luminances of light sources included in the backlight to increase, thereby compensating for a display luminance reduction of the subpixels due to the tone values being decreased.

### Effect of the Invention

According to the first aspect of the present invention, when a tone value exceeding a predetermined limit is to be provided to any subpixel of a specific color included in the display panel, the luminance adjustment portion decreases tone values to be provided to all subpixels of the specific color to a predetermined limit or less, and correspondingly decreases tone values to be provided to all subpixels of the other colors, so that color balance can be maintained between the specific color and the other colors, and the lighting control portion controls the luminance of the light sources to increase, thereby compensating for a display luminance reduction of the subpixels, so that a high luminance can be achieved.

According to the second aspect of the present invention, when the maximum calculated by the maximum value calculation portion for the tone values to be provided to the subpixels of the specific color included within one frame period is greater than or equal to a predetermined limit, the luminance adjustment portion decreases the tone values, and the lighting control portion increases the luminances of the light sources in accordance with the maximum value, so that a high luminance can be achieved while maintaining color balance for all pixels.

According to the third aspect of the present invention, the specific-color correction portion multiplies the tone values to be provided to the subpixels of the specific color by a predetermined correction gain, thereby generating corrected tone values, so that the specific color can be appropriately corrected even if it is dark (due to, for example, a small pixel area), and the luminance decrease adjustment portion multiplies the tone values by a predetermined adjustment gain, thereby decreasing the tone values, so that, for example, by adjusting the luminances of the light sources using a coefficient corresponding to the adjustment gain, a high luminance can be achieved in a simple manner while maintaining color balance.

According to the fourth aspect of the present invention, the luminance adjustment portion includes a polychromatic allocation portion for allocating red, green, and blue pixel data included in the video data to the tone values to be provided to the subpixels of four or more colors, and therefore, for example, the aforementioned operation of the luminance adjustment portion can be performed in a simplified manner during the course of polychromatic processing.

According to the fifth aspect of the present invention, each of the pixels includes at least a white subpixel, in addition to red, green, and blue subpixels, and therefore, for example, except for the case where the red, green, or blue display luminance is particularly higher than others (typically, when all display luminances are at their maximum value), a higher display luminance can be achieved than in the case where each pixel is composed of red, green, and blue subpixels.

According to the sixth aspect of the present invention, by the luminance adjustment portion adjusting a deficient luminance due to the subpixel of the specific color green having a smaller display area than at least one of the subpixels of the other colors, pixel color balance can be prevented from being disturbed, and the lighting control portion compensates for the luminance reduction, so that a high luminance can be achieved.

According to the seventh aspect of the present invention, each of the pixels includes a yellow or cyan subpixel, or subpixels of both colors, in addition to red, green, and blue subpixels, and therefore, higher color reproducibility can be achieved than in the case where each pixel is composed of red, green, and blue subpixels.

According to the eighth aspect of the present invention, the subpixels of the specific color have a lower relative luminance than the subpixels of the other colors, and therefore, by the luminance adjustment portion adjusting the deficient relative luminance, pixel color balance can be prevented from being disturbed, and the lighting control portion compensates for the luminance reduction, so that a high luminance can be achieved.

The display method according to the ninth aspect of the present invention can achieve the same effect as the effect achieved by the first aspect of the invention.

### BRIEF DESCRIPTION OF THE DRAWINGS

FIG. 1 is a block diagram illustrating the configuration of a liquid crystal display device according to an embodiment of the present invention.

FIG. 2 is a block diagram illustrating a detailed configuration of a luminance balance adjustment portion in the embodiment.

FIG. 3 is a graph illustrating the relationship between pixel data inputted to a G correction portion and pixel data outputted therefrom in the embodiment.

FIG. 4 is a graph illustrating relative luminances of R, G, and B pixel data included in an RGB separate signal D_{rgb} in the embodiment.

FIG. 5 is a graph illustrating relative luminances of pixel data included in a corrected RGB separate signal D_{rgb′} in the embodiment.

FIG. 6 is a graph illustrating relative luminances of (backlight transmitted through) subpixels actually displayed on a liquid crystal panel in the embodiment.

FIG. 7 is a diagram illustrating an example pixel configuration including subpixels of three colors, red, green, and blue.

FIG. 8 is a diagram illustrating an example pixel configuration including subpixels of four colors, red, green, blue, and white.

FIG. 9 is a diagram illustrating an example pixel configuration where the areas of the white and green subpixels shown in FIG. 8 are reduced.

FIG. 10 is a block diagram illustrating the configuration of a liquid crystal display device in a variant of the embodiment.

FIG. 11 is a block diagram illustrating a detailed configuration of a signal re-adjustment portion in the variant.

### MODE FOR CARRYING OUT THE INVENTION

Hereinafter, an embodiment of the present invention will be described with reference to the accompanying drawings.

### 1. Overall Configuration

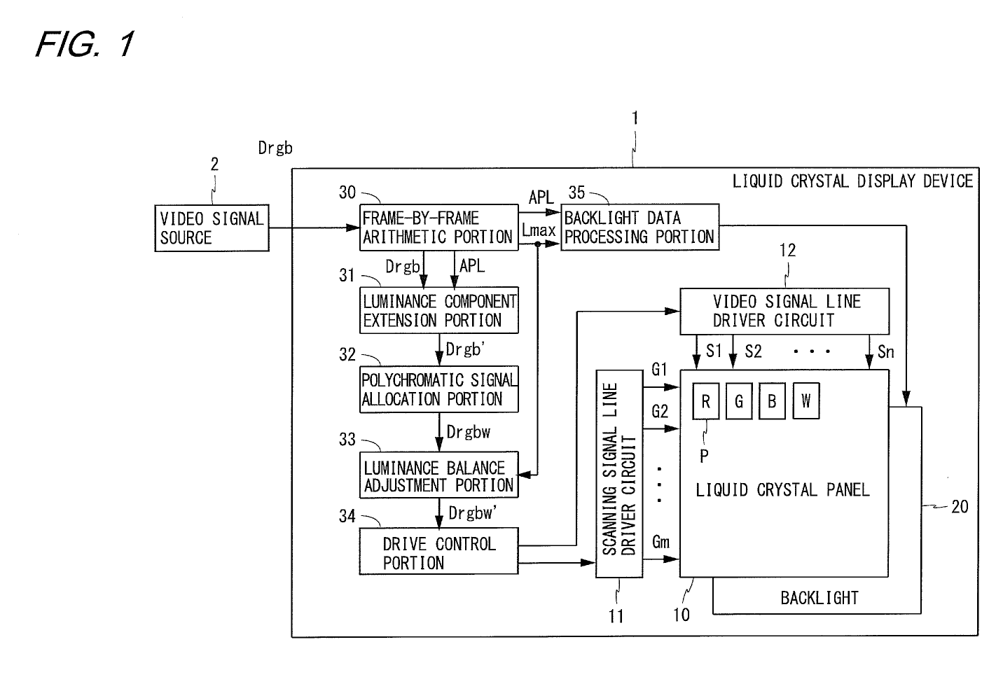

FIG. 1 is a block diagram illustrating the configuration of a liquid crystal display device according to an embodiment of the present invention. The liquid crystal display device 1 shown in FIG. 1 includes a liquid crystal panel 10, a scanning signal line driver circuit 11, a video signal line driver circuit 12, a backlight 20, a frame-by-frame arithmetic portion 30, a luminance component extension portion 31, a polychromatic signal allocation portion 32, a luminance balance adjustment portion 33, a drive control portion 34, and a backlight data processing portion 35. In the following, “m” is an integer of 2 or more, and “n” is a multiple of 4.

The liquid crystal panel 10 includes m scanning signal lines G₁ to Gₘ, n video signal lines S₁ to Sₙ, and (m×n) pixel circuits P. The scanning signal lines G₁ to Gₘ, are arranged in parallel with each other, and the video signal lines S₁ to Sₙ are arranged in parallel with each other so as to be perpendicular to the scanning signal lines G₁ to Gₘ. The pixel circuits P are provided in the vicinity of intersections of the scanning signal lines G₁ to Gₘ and the video signal lines S₁ to Sₙ. Each pixel circuit P is provided with a red, green, or blue color filter. However, the pixel circuits P that provide white display are provided with transparent films, rather than chromatic color filters. This is because their light sources are white, as will be described later. The pixel circuits P provided with the red, green, and blue color filters respectively function as red, green, and blue display elements. The pixel circuits P not provided with such color filters function as white display elements. These four types of pixel circuits P are arranged in the extending direction of the scanning signal lines G₁ to Gₘ (in FIG. 1, horizontally), and each set of the four forms a single pixel. Note that these four elements of the pixel will be referred to below as “subpixels”.

Here, in the pixel arrangement in the present embodiment, the areas of W and G, which have high display luminances per unit area, are small, as shown in FIG. 9 above. This is because such an arrangement increases color reproducibility for R and B. However, in some cases, this might result in deficiency of the display luminance (precisely, the luminosity) of G, but the present embodiment includes features for solving such a problem. Details thereof will be described later. Note that, strictly, the luminance, as a concept, does not depend on area, and the luminosities of the R, G, and B subpixels, when all of them are observed from a predetermined position, will also be simply represented below by the display luminances.

The scanning signal line driver circuit 11 and the video signal line driver circuit 12 are circuits for driving the liquid crystal panel 10. The scanning signal line driver circuit 11 drives the scanning signal lines G₁ to Gₘ, and the video signal line driver circuit 12 drives the video signal lines S₁ to Sₙ. More specifically, the scanning signal line driver circuit 11 selects one of the scanning signal lines G₁ to Gₘ in accordance with a timing control signal outputted by the drive control portion 34, and applies a selection voltage (e.g., a high-level voltage) to the selected scanning signal line and a non-selection voltage (e.g., a low-level voltage) to the remaining scanning signal lines. The video signal line driver circuit 12 applies voltages, which correspond to video signals outputted by the drive control portion 34, to the video signal lines S₁ to Sₙ in accordance with timing control signals outputted by the drive control portion 34. The video signal line driver circuit 12 may perform dot-sequential drive or line-sequential drive to drive the video signal lines S₁ to Sₙ.

The backlight 20 is provided behind the liquid crystal panel 10 to irradiate the back of the liquid crystal panel 10 with white light (backlight). The backlight 20 includes white LEDs as light sources whose luminance can be controlled. To control the LED luminance, the backlight data processing portion 35 outputs a PWM (Pulse Width Modulation) signal.

A video signal source 2 for outputting a composite video signal is provided outside the liquid crystal display device 1. The composite video signal outputted by the video signal source 2 is subjected to chroma processing, matrix transformation, etc., by an unillustrated signal processing portion, so that an RGB separate signal D_{rgb} is generated. The RGB separate signal D_{rgb} is provided to the frame-by-frame arithmetic portion 30 and the luminance component extension portion 31.

The frame-by-frame arithmetic portion 30 includes frame memory for storing the RGB separate signal D_{rgb} for one frame, and calculates an average picture level (hereinafter, abbreviated as an “APL”), which is an average luminance for pixel data included in RGB separate signal D_{rgb} stored in the frame memory for one frame period. The frame-by-frame arithmetic portion 30 also calculates the maximum value Lₘₐₓ of the pixel data for G inputted within the frame period. The calculated APL is provided to the luminance component extension portion 31 and the backlight data processing portion 35, and the calculated maximum value Lₘₐₓ is provided to the luminance balance adjustment portion 33 and the backlight data processing portion 35. The maximum value Lₘₐₓ will be described in detail later.

Here, when the APL is low, displayed images are generally dark, and therefore, the emission luminance of the backlight 20 does not have to be the maximum luminance. Accordingly, as the APL decreases, the emission luminance of the backlight 20 is reduced, and the liquid crystal transmittance of each pixel is increased to compensate for the reduction, thereby reducing power consumption of the backlight 20.

To reduce power consumption as described above, the luminance component extension portion 31 calculates a luminance component extension rate for increasing the liquid crystal transmittance for each pixel, thereby compensating for a reduction in the emission luminance of the backlight 20, whose emission luminance decreases with the APL, as described below, on the basis of a predetermined look-up table, a calculation formula, and so on.

The luminance component extension portion 31 outputs a corrected RGB separate signal D_{rgb′} generated by multiplying a pixel data value of each color included in the RGB separate signal D_{rgb} by the calculated luminance component extension rate.

On the basis of the R, G, and B pixel data included in the corrected RGB separate signal D_{rgb′} outputted by the luminance component extension portion 31, the polychromatic signal allocation portion 32 calculates corresponding W pixel data with reference to, for example, a predetermined look-up table, a calculation formula, etc., and adds the calculated W pixel data to the corrected RGB separate signal D_{rgb′}, thereby generating an RGBW signal D_{rgbw} for output.

The luminance balance adjustment portion 33 corrects input pixel data for G included in the RGBW signal D_{rgbw} outputted by the polychromatic signal allocation portion 32, in order to compensate for a reduction in the display luminance (precisely, the luminosity) at the time of monochromatic display due to each pixel being composed of subpixels of four colors, concretely, a reduction in the display luminance (precisely, the luminosity) of G whose display area is about half of that in the conventional pixel configuration. Moreover, RGB input pixel data is corrected, such that the display luminance upon display of G does not exceed the maximum luminance, on the basis of the maximum value Lₘₐₓ (of the input pixel data for G) received from the frame-by-frame arithmetic portion 30. Detailed configurations thereof will be described later.

The backlight data processing portion 35 obtains backlight data equivalent to emission luminances of the light sources for use in driving the backlight 20, on the basis of the APL and the maximum value Lₘₐₓ provided by the frame-by-frame arithmetic portion 30, and generates a PWM signal for driving LEDs in backlight units, with reference to predetermined PWM data on the basis of the backlight data. The generated PWM signal is supplied to an LED backlight board, and used for LED luminance control.

Here, the relationship between the APL and the emission luminances (backlight data) is defined by a predetermined look-up table and a calculation formula devised so as to correspond to the look-up table and the calculation formula in the luminance component extension portion 31. However, unlike in the foregoing, the emission luminances of the light sources are not maximized when the APL is maximized, and the light sources may be controlled to have a predetermined characteristic that allows the emission luminances thereof to be maximized when the value of the APL is about 60 percent of its maximum value. In this case, the predetermined look-up table, etc., in the luminance component extension portion 31 may be similarly characterized. Note that the relationship between the maximum value Lₘₐₓ and the emission luminance will be described later.

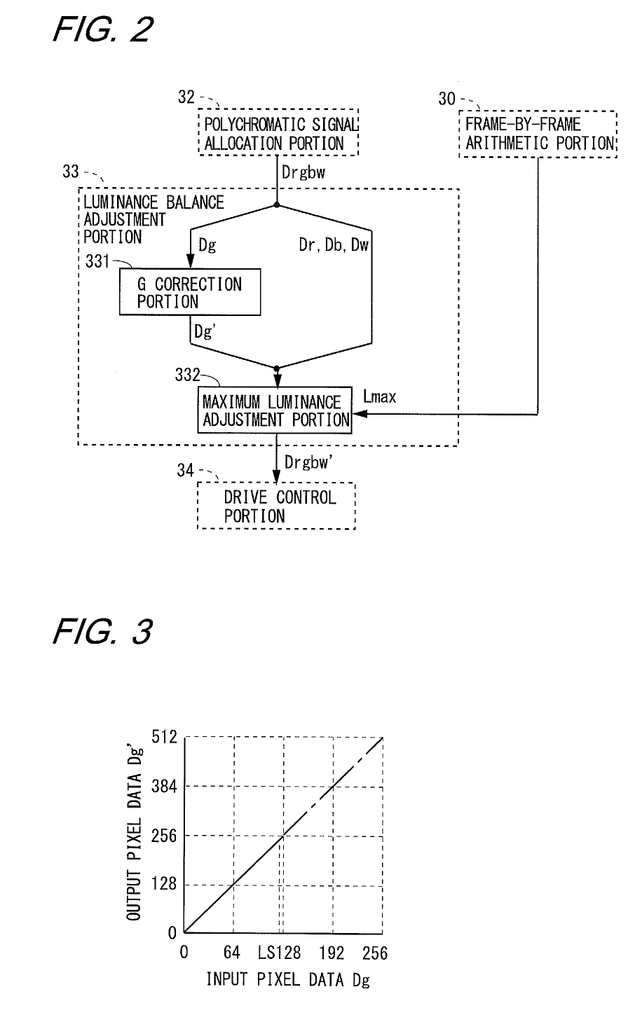

The drive control portion 34 outputs a timing control signal to the scanning signal line driver circuit 11 and also outputs a timing control signal and a video signal to the video signal line driver circuit 12. The scanning signal line driver circuit 11 and the video signal line driver circuit 12 drive the liquid crystal panel 10 on the basis of the signals outputted by the drive control portion 34. This changes the light transmittance of the pixel circuits P in the liquid crystal panel 10. On the other hand, the LEDs in the backlight 20 emit light with luminances corresponding to the backlight data obtained by the backlight data processing portion 35. The display luminance of each pixel in the liquid crystal panel 10 changes in accordance with the luminances of the LEDs and the light transmittance of the pixel circuits P. Therefore, a desired image can be displayed by obtaining appropriate video data and backlight data on the basis of the RGB separate signal D_{rgb} (from the video signal source 2) and driving the liquid crystal panel 10 and the backlight 20 using them. A detailed configuration and operation of the luminance balance adjustment portion 33 will be described next with reference to FIGS. 2 to 6.

### 2. Configuration and Operation of the Luminance Balance Adjustment Portion

FIG. 2 is a block diagram illustrating a detailed configuration of the luminance balance adjustment portion 33. The luminance balance adjustment portion 33 includes a G correction portion 331 and a maximum luminance adjustment portion 332, as shown in FIG. 2.

The G correction portion 331 receives input pixel data for G included in the RGBW signal D_{rgbw} from the polychromatic signal allocation portion 32, and corrects the input pixel data for G with a predetermined correction gain (coefficient) in order to compensate for a reduction in the display luminance (precisely, the luminosity) at the time of monochromatic display due to each pixel being composed of subpixels of four colors, here, particularly, a reduction in the display luminance due to the area of (subpixel) G being half of others as shown in FIG. 9.

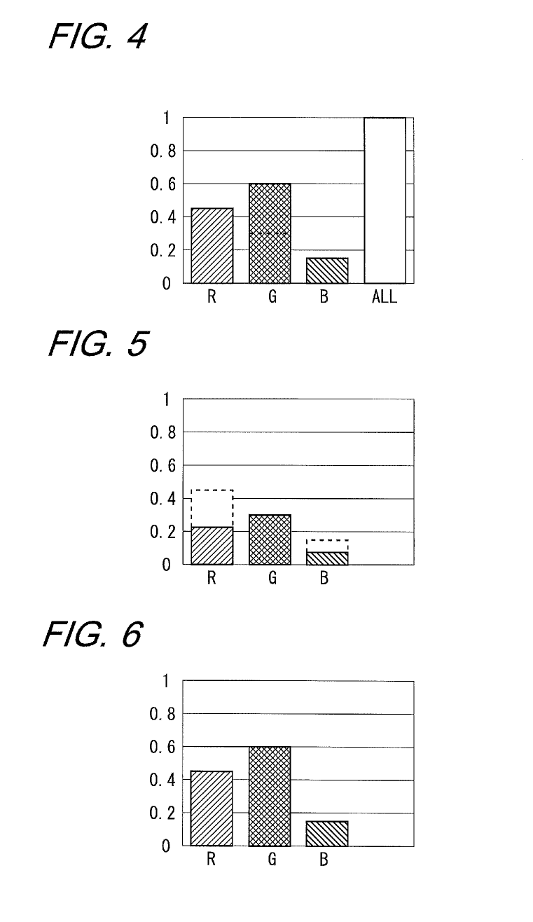

FIG. 3 is a graph illustrating the relationship between pixel data inputted to the G correction portion and pixel data outputted therefrom. When input pixel data D_{g}, which is display tone data inputted to the G correction portion 331, has a value of up to a predetermined limit Lₛ (here, 127), it is outputted as output pixel data D_{g′} after being multiplied by a coefficient (correction gain) of 2, and when the value exceeds the predetermined limit Lₛ, the maximum display tone value, 255, is outputted as output pixel data D_{g′}. If the value exceeding the limit Lₛ is multiplied by the coefficient, the value of the output pixel data D_{g′} exceeds 255, as indicated by the dotted line shown in FIG. 3. Note that since the coefficient (correction gain) is set so as to compensate for the reduction in the display luminance, the limit Lₛ is predetermined in accordance with the pixel configuration. The reduction in the display luminance will be concretely described with reference to FIGS. 4 to 6.

FIG. 4 is a graph illustrating relative luminances of R, G, and B pixel data included in the RGB separate signal D_{rgb}, FIG. 5 is a graph illustrating relative luminances of pixel data included in the corrected RGB separate signal D_{rgb′}, and FIG. 6 is a graph illustrating relative luminances of (backlight transmitted through) subpixels actually displayed on the liquid crystal panel 10.

Note that for convenience of explanation, it is assumed here that input pixel data Dᵣ, D_{g}, and D_{b} included in the RGB separate signal D_{rgb} are data representing maximum luminances, i.e., their display tone values are 255.

In FIGS. 4 to 6, the relative luminance shown on the vertical axis is the luminance at which to provide display per subpixel where the display luminance at which to provide display by all of the R, G, and B subpixels is 1, and, for example, in FIG. 4, the relative luminance of G is about 0.6, by which it can be appreciated that the luminance of G to be displayed is about 0.6 times the total luminance of R, G, and B to be displayed.

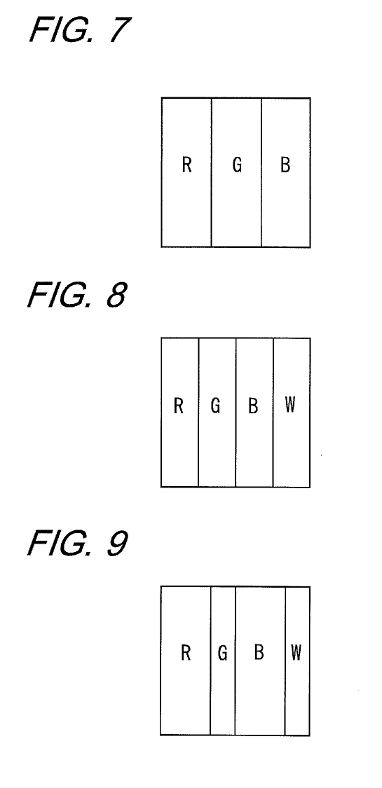

Here, the relative luminance of G shown in FIG. 4 actually represents the relative luminance of G in the conventional pixel configuration shown in FIG. 7. In the pixel configuration of the present embodiment shown in FIG. 9, the display area of G is about half of that in the conventional pixel configuration, and therefore, the relative luminance of G to be actually displayed is reduced to the dotted line shown in FIG. 4. Therefore, the G correction portion 331 performs a correction to compensate for the reduction in the display luminance.

Specifically, as described above, the G correction portion 331 outputs output pixel data D_{g′} by multiplying input pixel data D_{g} by a coefficient (correction gain) of, here, 2 as shown in FIG. 3. Here, when the predetermined limit Lₛ shown in FIG. 3 is exceeded, the output pixel data D_{g′} exceeds the maximum display tone value, 255, but this causes no problem because the maximum luminance adjustment portion to be described below corrects the value to be less than or equal to the upper limit that allows display on the display panel.

The maximum luminance adjustment portion 332 receives the maximum value Lₘₐₓ of the pixel data for G inputted within one frame period from the frame-by-frame arithmetic portion 30, and calculates an adjustment value (adjustment gain) by which to multiply output pixel data D_{g′} obtained by the G correction portion 331 correcting the input tone data D_{g} corresponding to the maximum value Lₘₐₓ, such that the maximum value does not exceed the maximum display tone value, 255, specifically, the input tone data D_{g} being corrected by the luminance component extension portion 31 and set by the polychromatic signal allocation portion 32. The maximum luminance adjustment portion 332 outputs the RGB separate signal D_{rgb′} obtained via correction in which the output pixel data D_{g′} and the input pixel data Dᵣ, D_{b}, and D_{w} are multiplied by the adjustment gain.

For example, when the maximum value Lₘₐₓ is 255, the maximum value of the pixel data D_{g} inputted within one frame period is assumed to be (simply, for convenience of explanation) 255, and therefore, the maximum value of the output pixel data D_{g′} is obtained by multiplying 255 by the correction gain (here, 2), as can be appreciated from FIG. 3. Accordingly, if the adjustment gain is set to the inverse of the correction gain, the pixel data D_{g′} included in the corrected RGB separate signal D_{rgb′} outputted by the maximum luminance adjustment portion 332 does not exceed 255.

Therefore, the adjustment gain may be set to the inverse of the correction gain, but, for example, when the maximum value Lₘₐₓ is greater than the limit Lₛ but less than the maximum value, 255, a value obtained by further multiplying the inverse of the correction gain by (255/Lₘₐₓ) may be used as the adjustment gain, such that the maximum value of the pixel data D_{g′} included in the corrected RGB separate signal D_{rgb′} is 255.

When the maximum value Lₘₐₓ is less than or equal to the limit Lₛ, the pixel data D_{g′} included in the corrected RGB separate signal D_{rgb′} does not exceed 255. Accordingly, in this case, the adjustment gain may be set to 1, or may be set to (255/Lₘₐₓ) such that the maximum value of the pixel data D_{g′} included in the corrected RGB separate signal D_{rgb′} is 255.

Here, when the maximum value Lₘₐₓ is 255, the pixel data D_{g′} included in the RGB separate signal D_{rgb′} is 255, but other corresponding pixel data D_{rbw′} is not multiplied by the correction gain, and therefore, naturally takes a value less than 255. Accordingly, as shown in FIG. 5, the relative luminance of G does not change from the relative luminance for actual display indicated by the dotted line in FIG. 4, while the relative luminances of R and B are reduced. The portions indicated by the dotted lines in FIG. 5 represent the relative luminances for actual display, including the portions indicated by the dotted lines in FIG. 4, for easy observation of the reductions.

As can be appreciated in comparison with the relative luminances shown in FIG. 4, the relative luminances of R, G, and B in the pixel configuration of the present embodiment shown in FIG. 5 are lower than (reduced from) the relative luminances of R, G, and B in the conventional pixel configuration shown in FIG. 7, but the ratio (balance) among the relative luminances is approximately equal to the conventional ratio. Therefore, by increasing the backlight source luminance to compensate for the reductions, it is rendered possible to realize approximately the same light intensity and color balance as in the conventional liquid crystal display device with the pixel configuration shown in FIG. 7 where each pixel is composed of subpixels of three colors R, G, and B.

Accordingly, the backlight data processing portion 35 obtains backlight data corresponding to the emission luminances of the light sources for use in driving the backlight 20, on the basis of the maximum value Lₘₐₓ, such that the backlight source luminance increases to compensate for the luminance reductions caused by the increase of the maximum value Lₘₐₓ. By increasing the backlight source luminance in this manner, the relative luminances of (backlight transmitted through) subpixels for actual display on the liquid crystal panel 10 can be approximately the same as in the conventional liquid crystal display device with the three-color, RGB, pixel configuration as shown in FIG. 6.

### 3. Effect

In this manner, in the present embodiment, the backlight data processing portion 35 sets the backlight source luminance to be high enough to compensate for a display luminance reduction caused by the maximum luminance adjustment portion 332 multiplying input pixel data for G by an adjustment gain, such that the value of the input pixel data for G does not exceed the maximum pixel value, after the G correction portion 331 corrects the input pixel data for G to compensate for a display luminance reduction due to the area of (subpixel) G being half of others. Thus, it is possible to realize high color reproducibility and a high luminance as realized by conventional liquid crystal display devices with the three-color, RGB, pixel configuration, which makes it possible to provide a display device ensured with a high luminance and satisfactory color balance of a display panel with each pixel being composed of subpixels of four or more colors.

### 4. Variants

### 4.1 Primary Variant

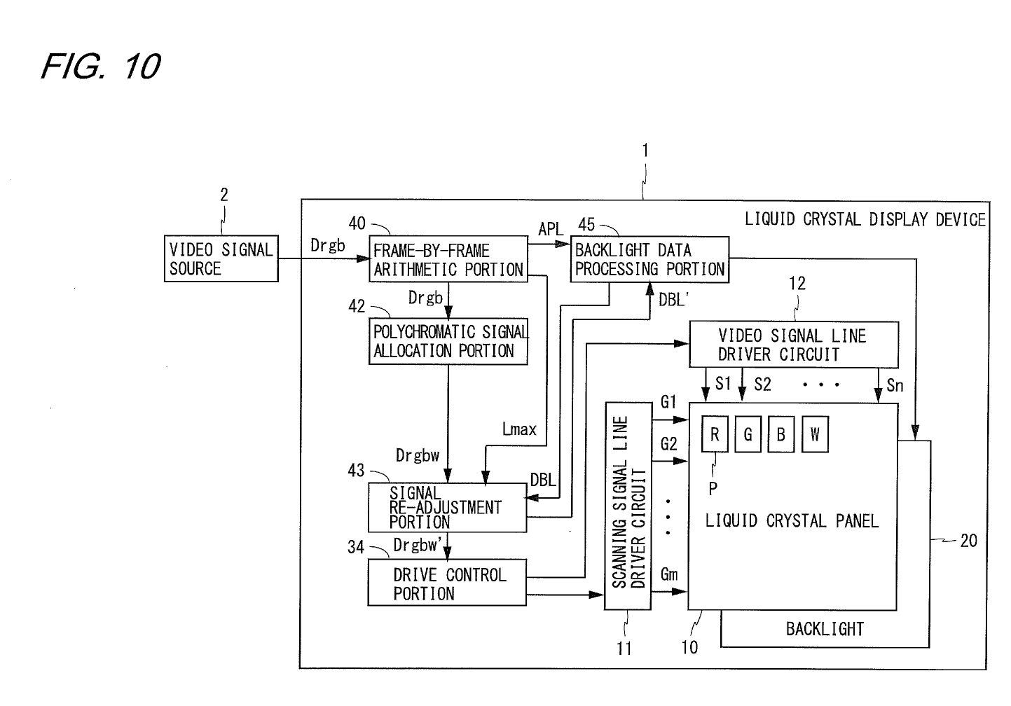

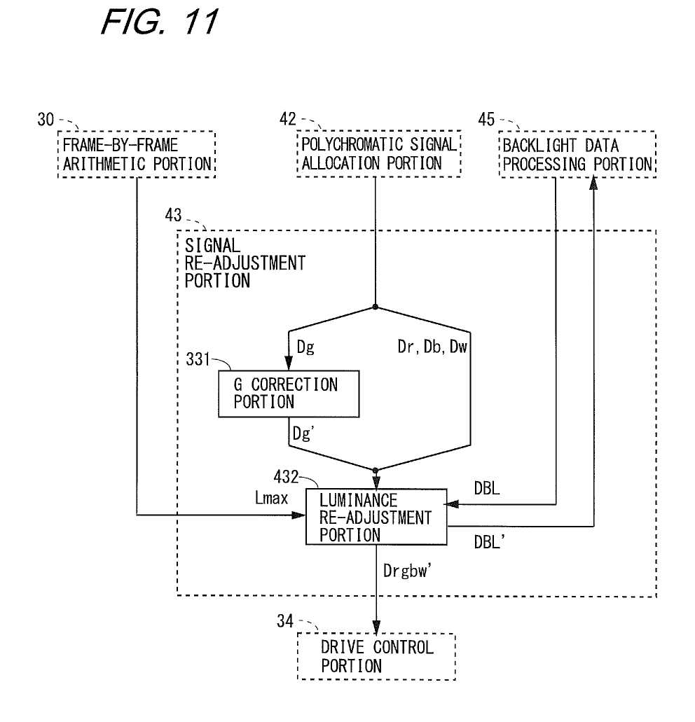

In the above embodiment, the backlight data processing portion 35 is configured to calculate backlight data on the basis of the relationship of the APL and the maximum value Lₘₐₓ with respect to the emission luminance (backlight data), which is defined by a predetermined look-up table, a calculation formula, etc., being set so as to correspond to the look-up table and calculation formula in the luminance component extension portion 31, but the backlight data may be obtained simply on the basis of the APL in the same manner as in the conventional art, and then adjusted, i.e., corrected, for the relationship between the maximum value Lₘₐₓ and the emission luminance in a component equivalent to the luminance balance adjustment portion 33. Moreover, the correction as performed by the luminance component extension portion 31 may be performed by the component equivalent to the luminance balance adjustment portion 33. Such a configuration will be described below with reference to FIGS. 10 and 11.

FIG. 10 is a block diagram illustrating the configuration of a liquid crystal display device in a variant of the above embodiment. In the liquid crystal display device of the present variant, as shown in FIG. 10, the luminance component extension portion 31 is omitted from the configuration of the embodiment shown in FIG. 1, a multi-signal allocation portion 42 receives an uncorrected RGB separate signal D_{rgb} from the frame-by-frame arithmetic portion 40, the backlight data processing portion 45 obtains backlight data D_{BL} simply on the basis of the APL provided by the frame-by-frame arithmetic portion 40, as described above, in the same manner as in the conventional art, the relationship between the maximum value Lₘₐₓ and the emission luminance is adjusted by a signal re-adjustment portion 43, as will be described later, and corrected backlight data D_{BL′} obtained by the adjustment is received.

Note that other components, which operate in the same manner as in the embodiment, are denoted by the same characters, and any descriptions thereof will be omitted. A detailed configuration and operation of the signal re-adjustment portion 43 will be described next with reference to FIG. 11.

FIG. 11 is a block diagram illustrating a detailed configuration of the signal re-adjustment portion in the variant. As shown in FIG. 11, in addition to the G correction portion 331 included in the luminance balance adjustment portion 33 shown in FIG. 2, the signal re-adjustment portion 43 includes a luminance re-adjustment portion 432 having both the function of the maximum luminance adjustment portion 332 and the function of adjusting the relationship between pixels and backlight data as will be described later.

As with the maximum luminance adjustment portion 332, the luminance re-adjustment portion 432 first calculates an adjustment value (adjustment gain) to not cause the maximum value Lₘₐₓ to exceed the maximum display tone value, 255, and outputs a corrected RGB separate signal D_{rgb′}. Moreover, backlight data D_{BL} is corrected on the basis of the maximum value Lₘₐₓ, such that the backlight source luminance is set to be high enough to compensate for the aforementioned luminance reduction due to the maximum value Lₘₐₓ increasing (or the adjustment gain being set to be less than 1), and the corrected data is provided to the backlight data processing portion 45 as corrected backlight data D_{BL′}. In this manner, by increasing the backlight source luminance, the relative luminances of (backlight transmitted through) subpixels actually displayed on the liquid crystal panel 10 becomes similar to those in conventional liquid crystal display devices with the three-color, RGB, pixel configuration as shown in FIG. 10.

Note that when the maximum value Lₘₐₓ being multiplied by the calculated adjustment gain does not exceed 255 and the backlight data D_{BL} is calculated such that the backlight luminance decreases in accordance with the APL, it is preferable to increase the adjustment gain so as not to cause each output color's tone data to exceed 255. By doing so, power consumption of the backlight can be reduced. Moreover, in this case, if the maximum value Lₘₐₓ being multiplied by the calculated adjustment gain reaches 255, the backlight data D_{BL} is adjusted such that the backlight luminance increases, and is provided to the backlight data processing portion 45 as corrected backlight data D_{BL′}. This eliminates the need for the backlight data processing portion 45 to calculate the correspondence between the maximum value Lₘₐₓ and the backlight luminance, resulting in a simplified configuration.

### 4.2 Other Variants

In the above embodiment, the luminance balance adjustment portion 33 receives and corrects an RGBW signal D_{rgbw} subjected to polychromatic processing, from the polychromatic signal allocation portion 32, but the polychromatic signal allocation portion 32 may have part or all of the function of the luminance balance adjustment portion 33. For example, a simple configuration may be employed in which, by changing the ratio of tone values corresponding to luminances in allocation (for polychromatic processing) by the polychromatic signal allocation portion 32, G pixel data is determined so as to compensate for a display luminance reduction for G, and RGB pixel data is also determined on the basis of the maximum. value Lₘₐₓ, such that the display luminance for G does not exceed the maximum value.

In the above embodiment, the backlight 20 uses white LEDs as light sources, but in place of or in addition to them, a combination of red, green, and blue LEDs may be used as light sources, or a cold cathode fluorescent lamp (CCFL) may be used as a light source. Moreover, the liquid crystal panel 10 is provided with a number of display elements 21, including the liquid crystal, but in place of the liquid crystal, there may be provided shutter elements made of a well-known substance having electro-optic properties which make it possible to control the transmittance of light from the backlight 20.

While each of the embodiments has been described taking as an example the liquid crystal display device with each pixel being composed of subpixels of four colors, R, G, B, and W, the present invention is not limited to this. For example, the invention can be applied to liquid crystal display devices with each pixel being composed of subpixels of four colors, R, G, B, and Y or C (where C refers to cyan), or can be applied to liquid crystal display devices with each pixel being composed of subpixels of five or more colors. Moreover, the maximum value Lₘₐₓ is the maximum tone value for G in the embodiment, but it may be a maximum tone value for a specific color other than G, which is determined in accordance with, for example, the pixel configuration.

### INDUSTRIAL APPLICABILITY

The present invention is applied to display devices such as liquid crystal display devices, for example, and is suitable for display devices including display panels, such as liquid crystal panels, with each pixel being composed of subpixels of four or more colors.

### DESCRIPTION OF THE REFERENCE CHARACTERS

1 liquid crystal display device
2 video signal source
10 liquid crystal panel
11 scanning signal line driver circuit
12 video signal line driver circuit
20 backlight
30, 40 frame-by-frame arithmetic portion
31 luminance component extension portion
32, 42 polychromatic signal allocation portion
33 luminance balance adjustment portion
33 drive control portion
35, 45 backlight data processing portion
331 G correction portion
332 maximum luminance adjustment portion

1. A display device having a function of controlling a backlight luminance, comprising:
a display panel for displaying an image on the basis of external video data, having each pixel being composed of subpixels of four or more colors;
a backlight including light sources whose luminances are controllable;
a luminance adjustment portion for, when a tone value exceeding a predetermined limit is to be provided to any subpixel of a specific color among all pixels included in the display panel, decreasing tone values to be provided to all subpixels of the specific color to a predetermined limit or less and correspondingly decreasing tone values to be provided to all subpixels of the other colors; and
a lighting control portion for controlling the luminances of the light sources to increase, thereby compensating for a display luminance reduction of the subpixels due to the tone values being decreased.

2. The display device according to claim 1, further comprising a maximum value calculation portion for calculating a maximum of the tone values to be provided to the subpixels of the specific color included in the video data for one frame period, wherein,
when the maximum value calculated by the maximum value calculation portion is greater than or equal to a predetermined limit, the luminance adjustment portion decreases the tone values, and
the lighting control portion controls the luminance of the light sources to increase in accordance with the maximum value calculated by the maximum value calculation portion.

3. The display device according to claim 1, wherein the luminance adjustment portion includes:
a specific-color correction portion for multiplying the tone values to be provided to the subpixels of the specific color by a predetermined correction gain, thereby generating corrected tone values to be provided to the subpixels of the specific color; and
a luminance decrease adjustment portion for, when any of the corrected tone values is greater than or equal to the limit, multiplying both the corrected tone values and the tone values to be provided to the subpixels of the other colors by a predetermined adjustment gain, thereby decreasing the tone values.

4. The display device according to claim 1, wherein the luminance adjustment portion includes a polychromatic allocation portion for allocating red, green, and blue pixel data included in the video data to the tone values to be provided to the subpixels of four or more colors.

5. The display device according to claim 1, wherein each of the pixels includes at least a white subpixel, in addition to red, green, and blue subpixels.

6. The display device according to claim 5, wherein the specific color is green, and the green subpixel has a smaller display area than at least one of the subpixels of the other colors.

7. The display device according to claim 1, wherein each of the pixels includes a yellow or cyan subpixel, or subpixels of both colors, in addition to red, green, and blue subpixels.

8. The display device according to claim 1, wherein the subpixels of the specific color have a lower relative luminance than the subpixels of the other colors.

9. A display method for a display device having a function of controlling a luminance of a backlight, the method comprising:
a luminance adjustment step of, when a tone value exceeding a predetermined limit is to be provided to any subpixel of a specific color among all pixels included in a display panel, decreasing tone values to be provided to all subpixels of the specific color to a predetermined limit or less and correspondingly decreasing tone values to be provided to all subpixels of the other colors, wherein the display panel has pixels each being composed of subpixels of four or more colors, and displays an image on the basis of external video data; and
a lighting control step of controlling luminances of light sources included in the backlight to increase, thereby compensating for a display luminance reduction of the subpixels due to the tone values being decreased.
